(19) United States
(12) Patent Application Publication
(10) Pub. No.: US 2006/0027980 A1
(43) Pub. Date: Feb. 9, 2006

(54) Clamping device for machine tools

(76) Inventor: Karl Hiestand, Pfullendorf (DE)

Correspondence Address: Pandiscio & Pandiscio, 470 Totten Pond Road, Waltham, MA, 02451-1914, US

(21) Appl. No.: 11/185,140

(22) Filed: Jul. 20, 2005

(30) Foreign Application Priority Data
Aug. 5, 2004 (DE) 10 2004 037 964.5

(51) Int. Cl. B23B 31/16

(52) U.S. Cl. 279/119

(57) ABSTRACT

A clamping device for machine tools provided with a chuck, the clamping jaws of which are actuated by a draw rod, includes a motor and a driveline arranged between the motor and the draw rod, the driveline including gearing elements by means of which rotational movements of the motor required for moving the clamping jaws are converted into axial displacement movements of the draw rod. Rotational displacement movements only have to be performed by the motor of the clamping device in order to clamp a workpiece and to release the clamping jaws, in which case these rotational movements are converted into axial displacement movements by means of the driveline and are transmitted onto the draw rod.

The present invention relates to a clamping device for a machine tool that is equipped with a power-operated chuck for holding a workpiece, the clamping jaw of which can be actuated using the clamping device by means of an axially moveable draw rod.

Numerous very different embodiments of clamping devices of this kind have been disclosed. In many cases, such as for example DE 32 28 749 C2, the draw rod is moved by means of a piston that is connected to the draw rod, can have pressurised fluid acting on it on both sides and is inserted in a cylinder. Apart from the size of the pressure cylinder, these embodiments suffer from the disadvantage that a pressurised medium under high pressure must always be available in order to maintain the pressure in the cylinder and therefore the clamping force acting via the clamping jaws on a clamped workpiece. In electrical clamping devices such as EP 0 234 230 B1, for example, the complexity of the design is usually very considerable, although the most serious disadvantage in this case concerns the large number of components that are constantly rotating, leading to very loud noises during operation.

The task of the present invention is therefore to create a clamping device for machine tools of the aforementioned type which is small in size and therefore can be manufactured economically. Above all, it is the intention for the clamping force of the clamping jaws to be maintained without having to drive the components of the clamping device using a motor and thereby having to accept high operating noises. Furthermore, it should be possible for the clamping device to be actuated using both electrical energy and using a pressurised medium, thereby allowing for flexibility in operation with a wide range of functions and straightforward operation.

In accordance with the present invention, this is achieved in a clamping device of the aforementioned type in that the clamping device consists of a motor with a changeover function, preferably an electrical servomotor or hydraulic motor, as actuator and support element and, arranged between this and the draw rod, a driveline consisting of gearing elements by means of which the rotational displacement movements of the drive element of the motor needed to move the clamping jaws of the power-operated chuck can be converted into axial displacement movements of the draw rod.

In this case, it is advantageous for the driveline to be configured as a bell in a rotating mounting on the hollow shaft that is in a driven connection with the motor and, in a preferred embodiment, connected with the machine spindle, as well as an intermediate element supported in a non-rotating arrangement, the bell and the intermediate element being connected together by meshing thread elements in order to convert the rotating movements of the bell, and for the intermediate element to be in a driven connection with the draw rod either directly or via a sliding sleeve that carries the intermediate element, in order to actuate the draw rod.

In order to convert the rotational movements of the bell, it is advantageous for the bell to be allowed to engage with an intermediate element using an internal thread in the bell and an external thread on the intermediate element, for the intermediate element to be mounted in a non-rotating arrangement although remaining axially moveable and for the intermediate element to be in a driven connection with the draw rod. However, the bell can also be in a driven connection with the intermediate element by means of a roller thread drive provided, in a preferred embodiment, with a roller return function.

In order to achieve a driven connection between the intermediate element and the draw rod, it is possible for at least two reversing levers to be provided in a swiveling mounting on pins arranged in a fixed location, with the outer ends of the reversing levers being in a driven connection with the axially moveable sliding sleeve and the inner ends of the reversing levers connected to the draw rod. In this embodiment, the pins that carry the revering levers can be in a rotating mounting in the hollow shaft connected to the machine spindle of the machine tool and the outer and/or inner ends of the reversing levers should each be provided with a gearing profile or crowned in order to engage with the gearing profiles or recesses worked onto the axially moveable sliding sleeve and/or the draw rod.

In accordance with a different embodiment, at least two gears or toothed segments can be provided in order to bring the sliding sleeve into a driven connection with the draw rod, with the gears or toothed segments being in a rotating arrangement on a pin mounted in a sleeve that is in a fixed connection with the draw rod and engaging in the gearing profiles provided on the axially moveable sliding sleeve and on the hollow shaft which is in a fixed connection with the machine spindle.

The gearing profiles provided on the axially moveable sliding sleeve should each be formed by a toothed segment attached to them.

The bell and/or the axially moveable intermediate element should be in a rotational mounting on the hollow shaft connected to the machine spindle by means of spindle bearings.

In accordance with a further embodiment, provision is made for the bell, the axially moveable intermediate element, the sliding sleeve, the bearing race of the bell, the sleeve and/or additional components of the clamping device each to be provided with one or more coolant ducts, in a preferred embodiment in an axial arrangement, to which coolant can be supplied. In order to establish a backpressure in the clamping device, the coolant ducts can be provided with throttles, in a preferred embodiment in the end areas of the coolant ducts.

If a clamping device is configured in accordance with the present invention, the clamping force of the clamping jaws of the power-operated chuck can be maintained without the need for the components of the clamping device to rotate. Rotational displacement movements only have to be performed in order to clamp a workpiece and to release the clamping jaws by means of the motor of the clamping device, these rotational movements being converted into axial displacement movements by means of the driveline and transmitted to the draw rod.

The complexity of the construction by means of which this is to be achieved is slight, so that economical production of the clamping device is also possible, particularly since many commercially available components can be used. Above all, it is an advantage in this case that the external components of the clamping device are not connected to the machine spindle and do not rotate, so that there is no need to accept any associated operating noises. Also, the motor of the clamping device makes it possible to ascertain the particular displacement travel of the clamping jaws and accordingly their operating position without difficulty, meaning that additional monitoring is not required but can nevertheless be implemented in a straightforward manner. The proposed embodiment involves little design complexity and yet provides a clamping element that enables workpieces to remain clamped in a machine tool over long periods with a high degree of operational safety.

The drawing shows a sample embodiment and variants of the clamping device configured in accordance with the present invention, the details of which are explained below. In the drawing,

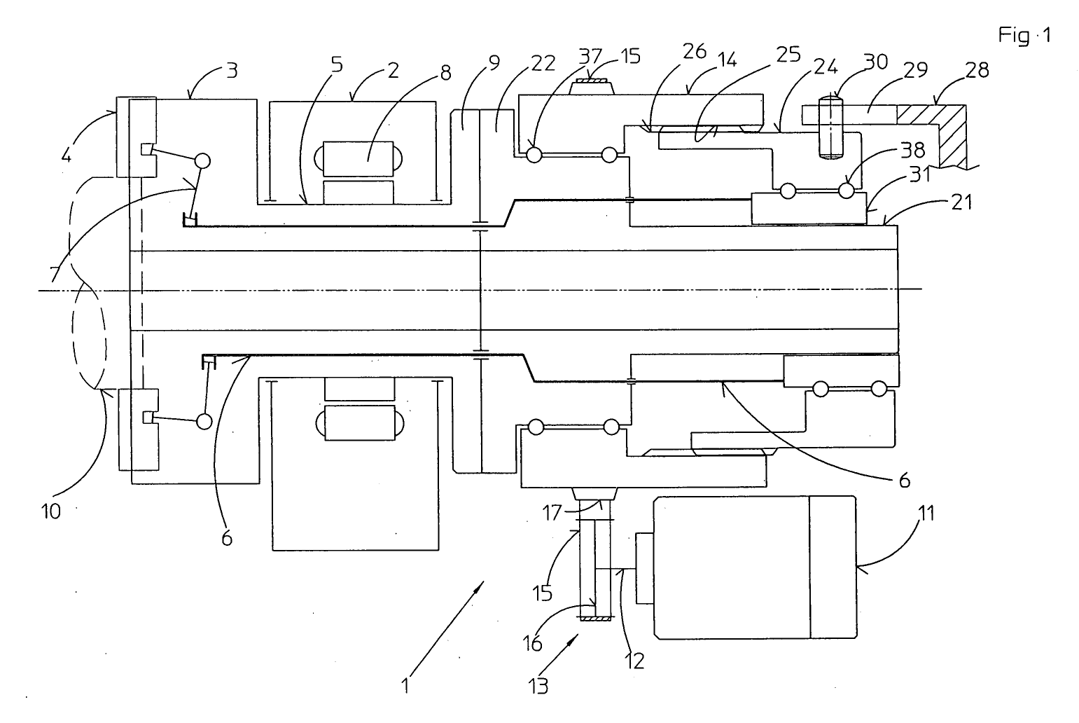

FIG. 1 shows a clamping device installed in a machine tool, in a schematic view and in various operating positions,

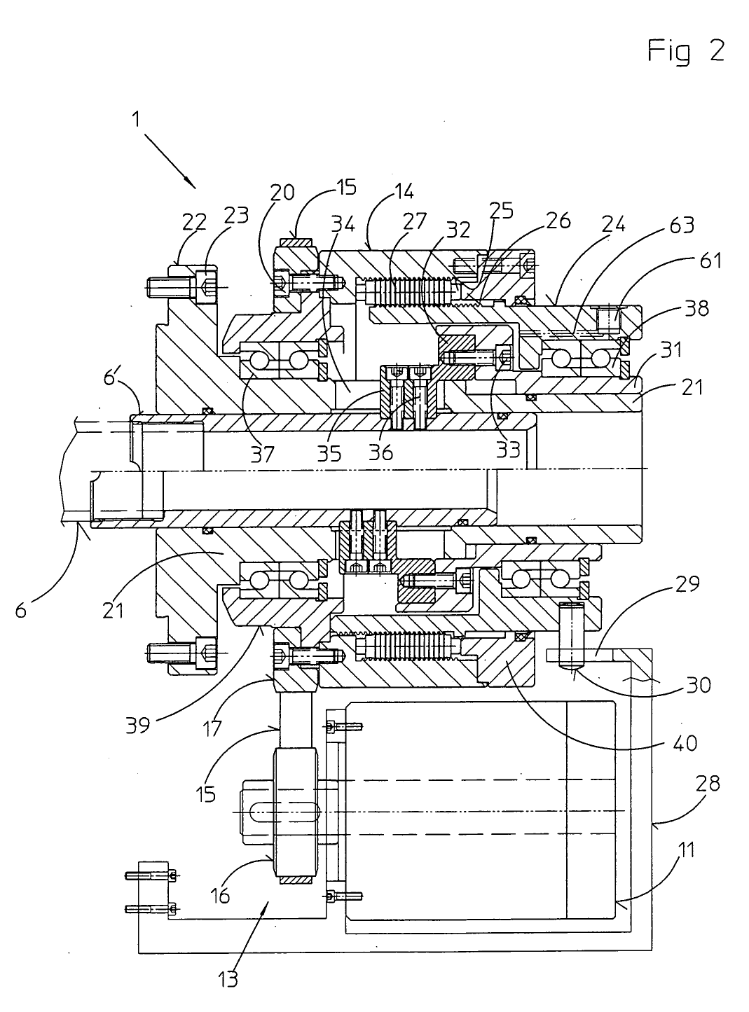

FIG. 2 the design characteristics of the clamping device in accordance with FIG. 1, in a longitudinal section and in various operating positions,

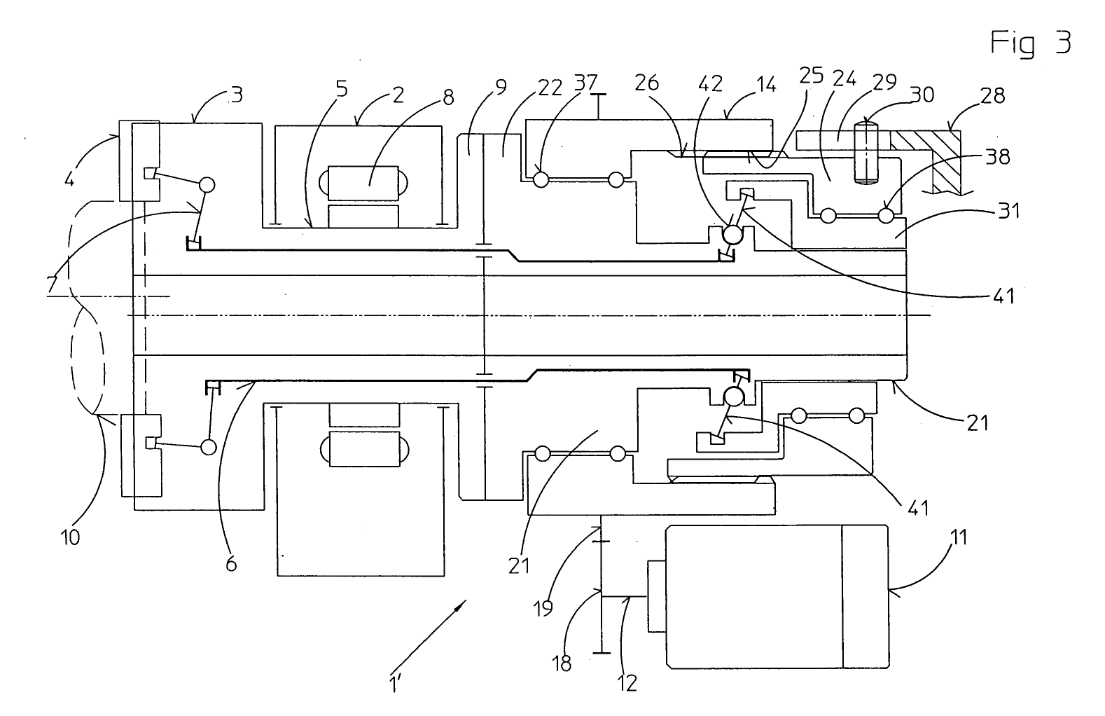

FIG. 3 a variant of the clamping device in accordance with FIG. 1, in a schematic view and in various operating positions,

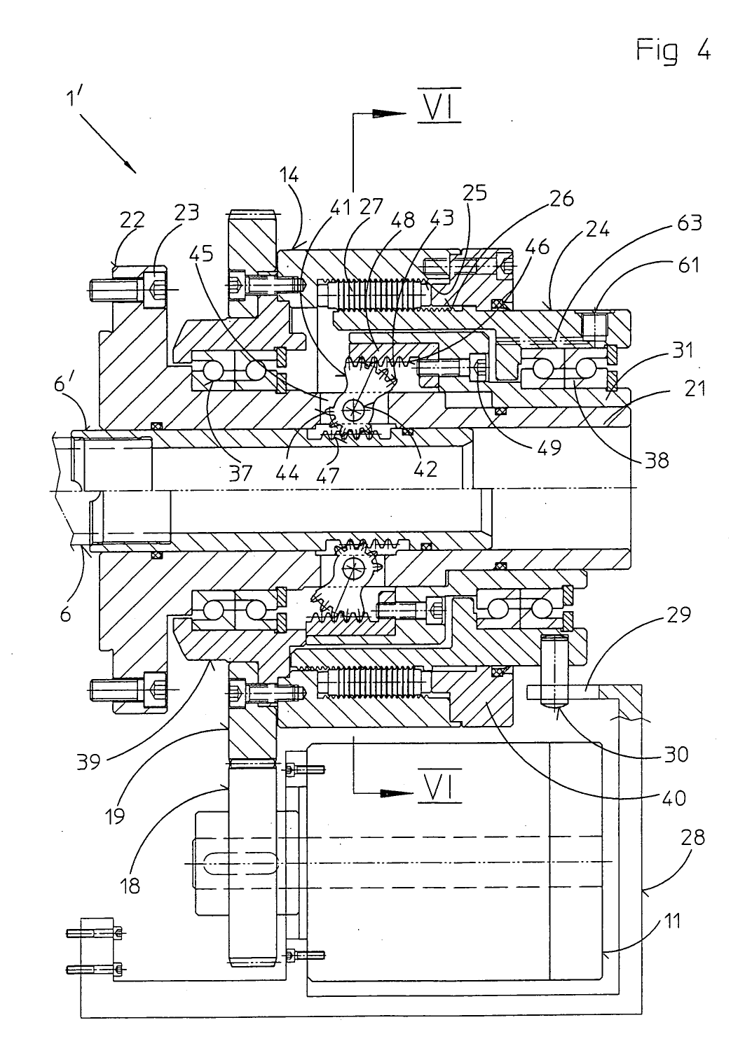

FIG. 4 the design characteristics of the clamping device in accordance with FIG. 1, in an axial section and in various operating positions,

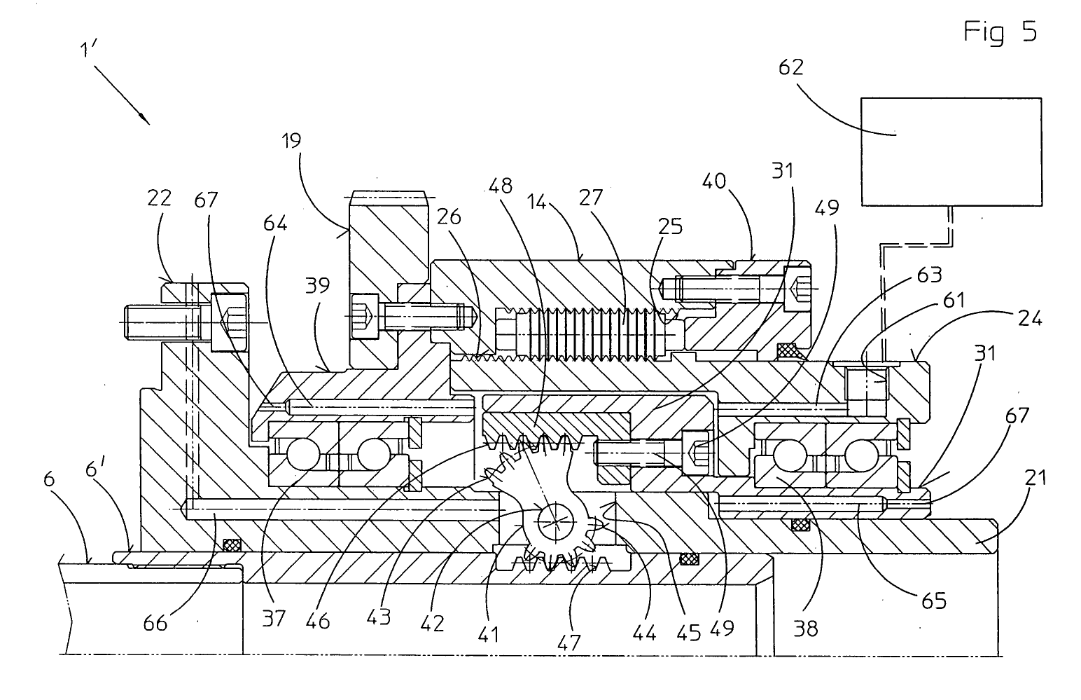

FIG. 5 a magnified view of the clamping device in accordance with FIG. 4, in a half section,

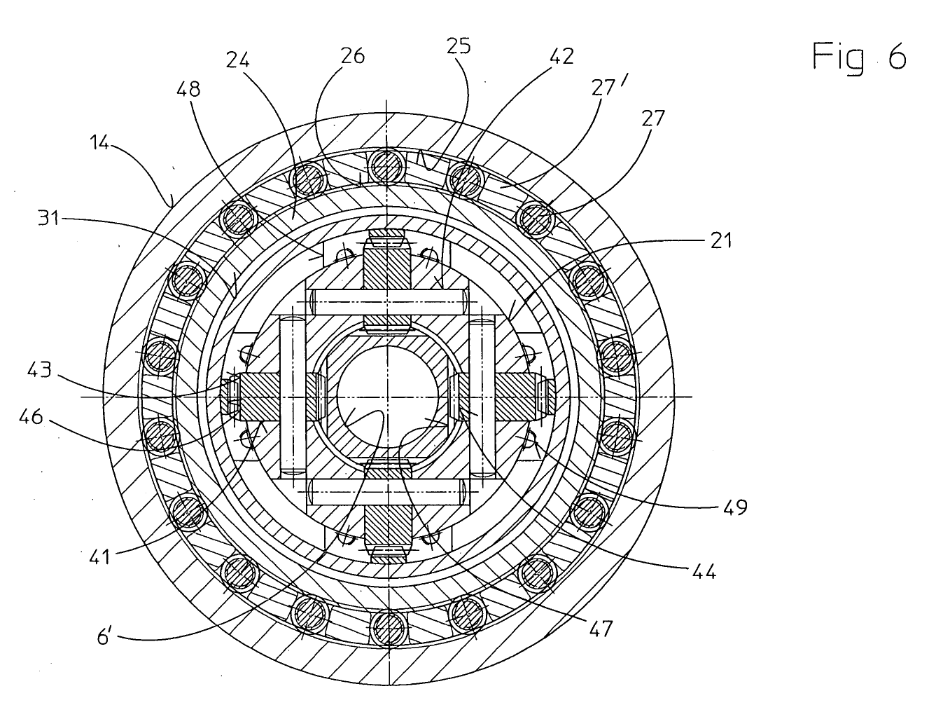

FIG. 6 a perpendicular section through the clamping device in accordance with FIG. 3 along the line VI-VI,

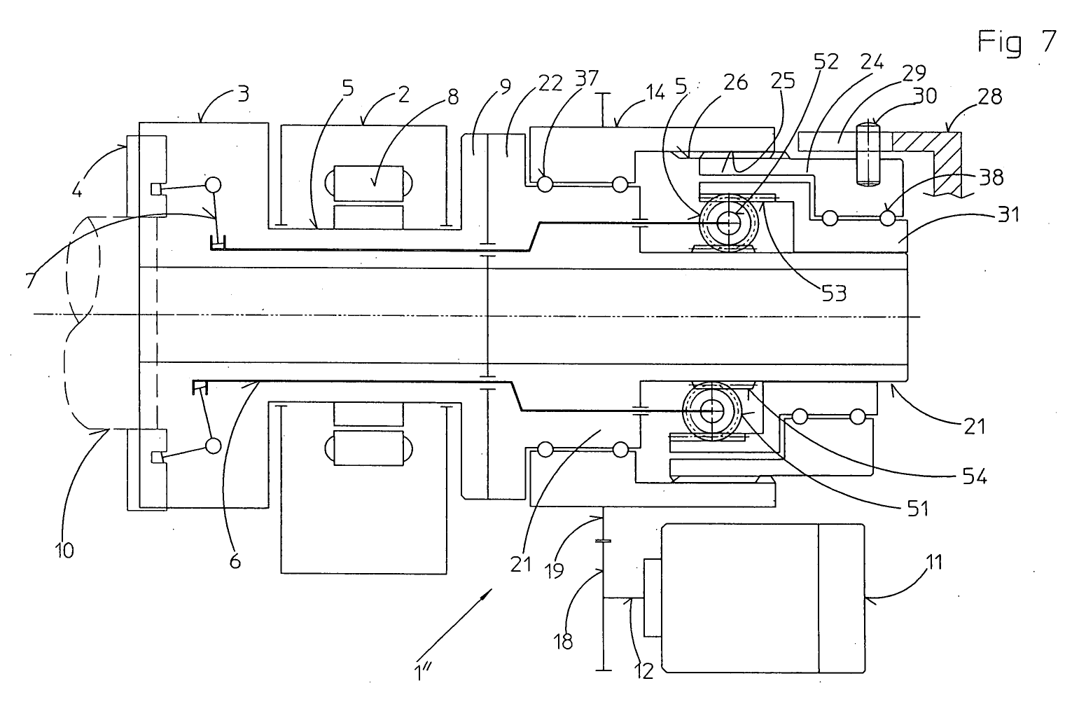

FIG. 7 another variant of the clamping device in accordance with FIG. 1, in a schematic view and in various operating positions,

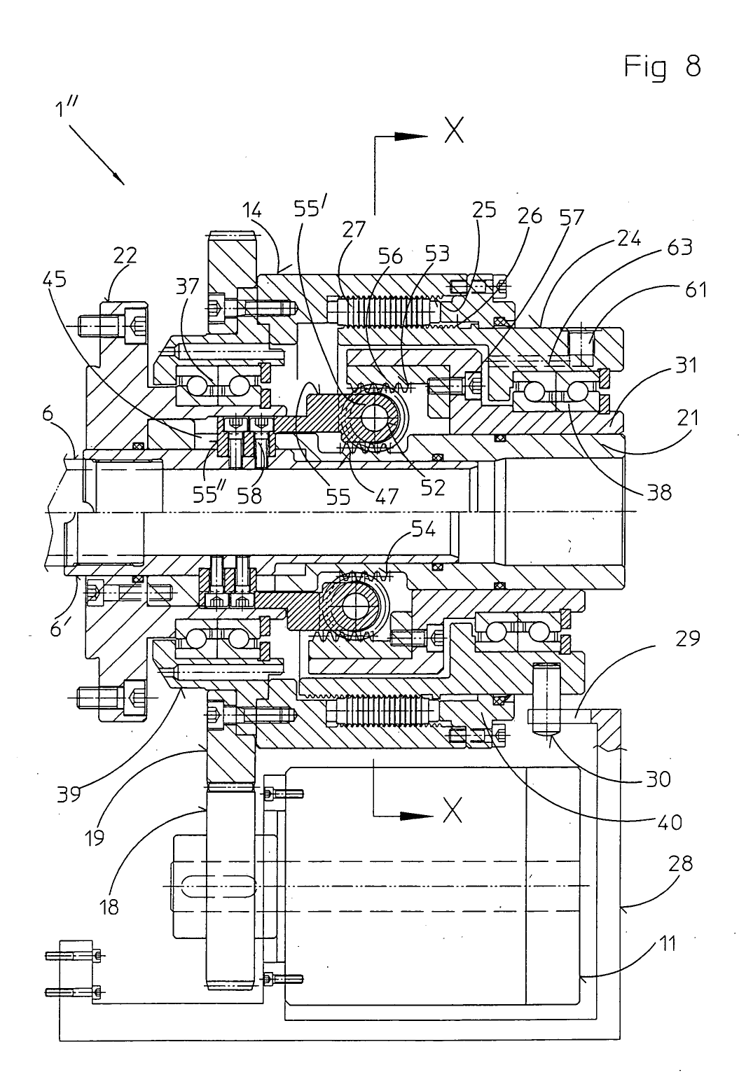

FIG. 8 the design characteristics of the clamping device in accordance with FIG. 7, in an axial section and in various operating positions,

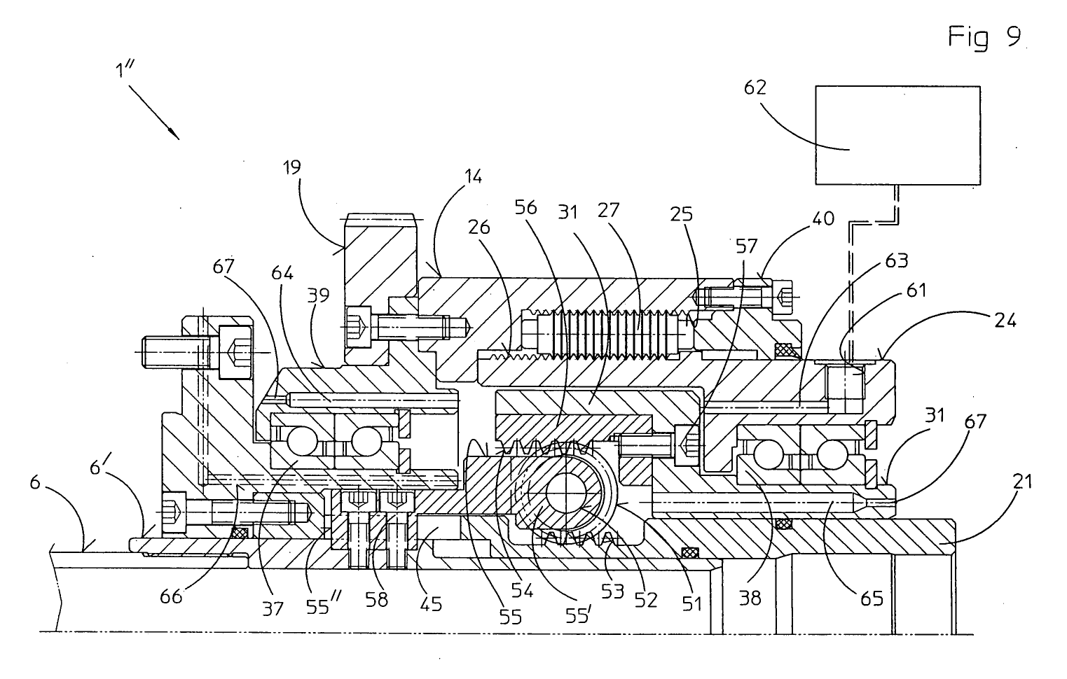

FIG. 9 a magnified view of the clamping device in accordance with FIG. 7, in a half section,

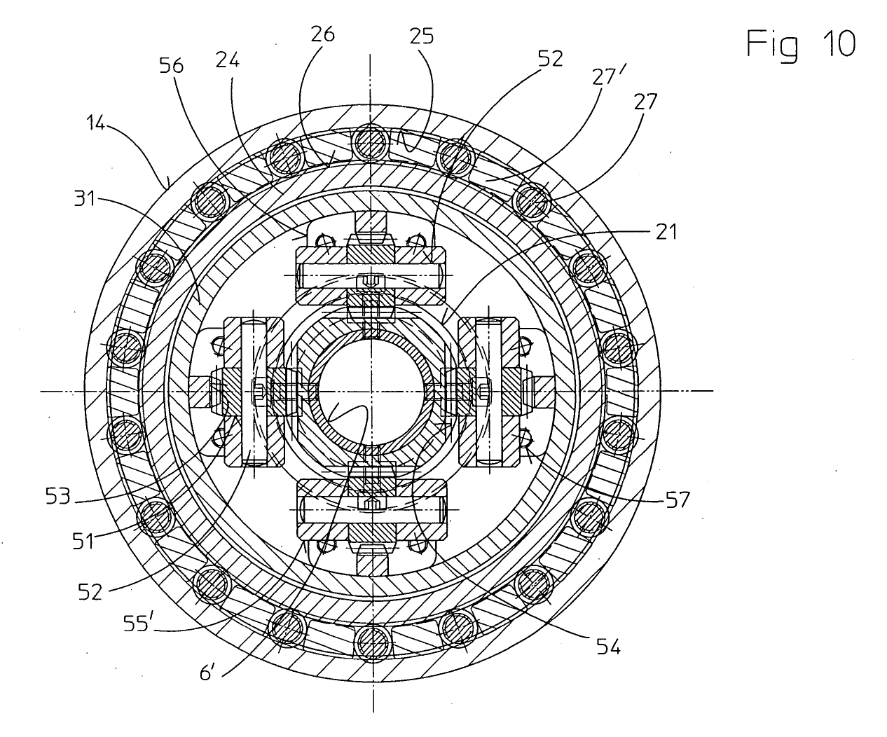

FIG. 10 a perpendicular section through the clamping device in accordance with FIG. 7 along the line X-X.

The clamping device illustrated in FIGS. 1, 3 and 7 in schematic form, in FIGS. 2, 4 and 8 in design form, in each case shown in different operating conditions and identified by 1, 1′ or 1″ is used for actuating a power-operated chuck 3 arranged on a machine tool 2, by means of the adjustable clamping jaw 4 of which a workpiece 10 to be machined can be clamped in the chuck 3, and chiefly consists of a motor 11 and a driveline 13 by means of which the rotational displacement movements of the motor 11 can be converted into axial displacement movements. The axial displacement movements triggered in the clamping device 1, 1′ or 1″ are transmitted to the clamping jaws 4 by means of a draw rod 6 that reaches through a spindle 5 of the machine tool 2 which can be driven by a motor 8 and, in the illustrated sample embodiments, is in a driven connection with the clamping jaws 4 by means of levers 7. Furthermore, the spindle 5 is provided with a flange 9 to which a hollow shaft 21 also equipped with a flange 22 is attached, with the hollow shaft 21 carrying the clamping device 1, 1′ or 1″.

The driveline 13 is formed by a bell 14 in a driven connection with the output element 12 of the motor 11, an intermediate piece 24 coupled to the bell 14 as well as a sleeve 31 to which the draw rod 6 is attached. In the sample embodiment illustrated in FIGS. 1 and 2, a toothed belt 15 is provided as a driven connection between the bell 14 and the output element 12 of the motor 11, this toothed belt 15 engaging with belt sheaves 16 or 17 attached to the output element 12 and the bell 14. In accordance with FIG. 3, however, the same purpose can be served by a countershaft gear unit formed using gears 18 and 19.

The displacement movements triggered by the motor 11, that can be configured as an electric servomotor or as a hydraulic motor, are transmitted to the bell 14 and its rotational movements are converted into axial displacement movements in interaction with the intermediate element 24. In order to achieve this, an internal thread 25 is worked into the bell 14 and the intermediate element 24 has an external thread 26. In addition, the intermediate element 24 is supported in a non-rotational arrangement by means of a projecting pin 30 that engages in a slot 29 in a holder 28, with the effect that a turning movement of the bell 14 in the intermediate element 24 causes the intermediate element 24 to be moved axially to the left or right. And since the intermediate element 24, as can be seen in particular in FIG. 2, is connected with a pipe section 6′ that is in a fixed connection with the draw rod 6, then the pipe section 6′ is moved in the same way.

In accordance with the design embodiment, the internal thread 25 of the bell 14 does not directly engage in the external thread 26 of the intermediate element 24 but instead via a roller thread drive that consists of rollers 27 (FIG. 6) arranged in a cage 27′ at spaced intervals from one another and with a return function. In this way, friction losses are reduced.

The intermediate element 24 is supported on the sleeve 31 in a rotational arrangement by means of a spindle bearing 38, by means of which axial displacement movements are transmitted to the sleeve 31. In order to transmit the adjustment movements onto the pipe section 6′, several ring segments 32 are attached to the sleeve 31 by means of screws 33 with a projection 35 fixed to the free end of each ring segment 32 by means of screws 36, these screws 36 passing through openings 34 worked into the hollow shaft 21 and being connected to the pipe section 6′ together with the bolts 36. The bell 14, to which the belt sheave 17 is attached and axially secured using screws 20, is also in a rotational mounting on the hollow shaft 21 by means of a spindle bearing 37. A bearing race 39 is provided for this purpose, being held on the bell 14 together with the belt sheave 17. At the end opposite to the belt sheave 17, the bell 14 is sealed by a screwed-on cover 40.

The motor 11 of the clamping device 1 only has to be operated briefly in order to open or close the chuck 3. Irrespective of whether the machine spindle 5 is stationary or is rotating together with the hollow shaft 21 attached to the machine spindle 5 by means of the flange 22 and bolts 23, the corresponding rotational displacement movements of the output element 12 are converted by means of the gearing elements of the driveline 13 and are transmitted onto the draw rod 6 as axial displacement movements, by means of which the clamping jaws 4 are actuated. After the workpiece 10 has been clamped, the clamping force is maintained by the motor 11 because this acts on the clamping jaws 4 in the same way with the given motor torque.

In the variants of the clamping device 1′ shown in FIGS. 3 to 6, several reversing levers 41 are arranged evenly around the circumference in order to transmit the axial displacement movements of the intermediate element 24 onto the draw rod 6 or onto the pipe section 6′ that is connected to the draw rod 6, these reversing levers 41 being held in a swiveling arrangement on pins 42 and reaching through apertures 45 provided in the hollow shaft 21. In this case, as can be seen in FIG. 6 in particular, the pins 42 are held in the hollow shaft 21 and the inner and outer ends of the reversing levers 41 are each equipped with a gearing profile 43 or 44. The reversing levers 41 engage in toothed segments 48 by means of gearing profiles 43 or 44, the toothed segments being provided with a gearing profile 46 and attached to the intermediate piece 24 by means of screws 49, while the reversing levers 41 also engage in gearing profiles 47 worked into the pipe section 6′, thereby creating a positive connection between the intermediate piece 24 and the pipe section 6′.

Due to the distance between the gearing profiles 43 and 44 of the reversing levers 41 and the middle axis of the pins 42, the ratio of the displacement travel of the intermediate element 24 can be adjusted so that, amongst other effects, high clamping forces can be transferred onto the clamping jaws 4.

In accordance with the variants of the clamping device 1″ shown in FIGS. 7 to 10, several gears 51 distributed around the circumference are used for transmitting the axial displacement movements of the intermediate element 24 onto the pipe section 6′ and therefore onto the draw rod 6 and the clamping jaws 4, these gears 51 being in a rotating mounting on pins 52 and engaging in gearing profiles 53 and 54. In turn, toothed segments 56 are attached to the gearing sections 53 on the tube 31 by means of screws 57, whereas the gearing profiles 54 are directly worked into the hollow shaft 21 that is connected to the machine spindle 5 in an axially fixed arrangement.

The pins 52 are held in attachments 55′ on a sleeve 55, the attachments 55′ being firmly attached to the pipe section 6′ using bolts 55. The axial displacement movements of the pins 52 that are triggered during an axial displacement of the intermediate piece 24 due to the rolling of the gears 41 in the gearing profiles 54 are therefore reduced by half and transmitted onto the pipe section 6′.

As can be seen in particular in FIGS. 5 and 9, the intermediate piece 24, the bearing race 39, the sleeve 31 and the hollow shaft 21 have several cooling ducts 63, 64, 65 or 66 worked into them, to which coolant, for example in the form of cooled air, is supplied from a cooling unit 62 via a connection 61 provided in the intermediate piece 24. The coolant ducts 63, 64 and 65 each have throttles 67 in their end areas, therefore a backpressure is set up in the clamping device 1, 1′ or 1″ with the result that the heat generated in the spindle bearings 37 and/or 38 and possibly in other components is absorbed by the coolant and is removed from the clamping device 1, 1′ or 1″.

1. A clamping device (1) for machine tools (2), the clamping device being provided with a power-operated chuck (3) for holding a workpiece (10), the chuck having clamping jaws (4) operable by means of an axially moveable draw rod (6);
wherein the clamping device (1) comprises a motor (11) with a changeover function, the draw rod (6), and a driveline (13) disposed between said motor and the draw rod, said driveline comprising gearing elements (15 or 18, 19, 24, 25, 26, 27) by means of which rotational displacement movements of a drive element (12) of said motor (11) needed to move the clamping jaws (4) of the power-operated chuck (3) are converted into axial displacement movements of the draw rod (6).

2. The clamping device in accordance with claim 1,
wherein
said driveline (13) is configured as a bell (14) in a rotating mounting on a hollow shaft (21) that is in a driven connection with said motor (11) and, connected with a machine spindle (5), as well as an intermediate element (24) supported in a non-rotating arrangement, the bell (14) and the intermediate element (24) being connected together by meshing thread elements (25, 26 or 25, 26, 27) to convert the rotating movements of the bell (14), and the intermediate element is in a driven connection with the draw rod by a selected one of (1) directly and (2) via a sliding sleeve (31) that carries the intermediate element (24), in order to actuate the draw rod (6).

3. The clamping device in accordance with claim 2,
wherein
the bell (14) that is mounted on the hollow shaft (21) by means of a roller bearing (37), and a bearing race (39) is in a driven connection with the drive element (12) of said motor (11) by means of a selected one of a toothed belt (15) and a countershaft gear unit (18, 19).

4. The clamping device in accordance with claim 2,
wherein
in order to convert the rotational movements of the bell (14), the bell (14) engages with an intermediate element (24) using an internal thread (25) in the bell (14) and an external thread (26) on the intermediate element (24), and the intermediate element (24) is mounted in a non-rotating arrangement although it remains axially moveable and in a driven connection with the draw rod (6).

5. The clamping device in accordance with claim 2,
wherein
the bell (14) is in a driven connection with the intermediate element (24) by means of a roller thread drive (27, 27′) provided with a roller return function.

6. The clamping device in accordance with claim 2,
wherein
in order to achieve a driven connection between the intermediate element (24) and the draw rod (6), at least two reversing levers (41) are provided in a swiveling mounting on pins (42) arranged in a fixed location, with the outer ends of the reversing levers (41) being in a driven connection with the axially moveable sliding sleeve (31) and the inner ends of the reversing levers (41) connected to the draw rod (6).

7. The clamping device in accordance with claim 6,
wherein
the pins (42) that carry the reversing levers (41) are in a rotating mounting in the hollow shaft (21) connected to the machine spindle (5) of the machine tool (2).

8. The clamping device in accordance with claim 6,
wherein
the outer and/or inner ends of the reversing levers (41) are each provided with a gearing profile (43, 44) to engage with gearing profiles (46, 47) worked onto the axially moveable sliding sleeve (31) and the draw rod (6).

9. The clamping device in accordance with claim 2,
wherein
at least two gears (51) are provided in order to bring the sliding sleeve (31) into a driven connection with the draw rod (6), the gears (51) being in a rotating arrangement on a pin (52) mounted in a sleeve (55) that is in a fixed connection with the draw rod (6) and engaging in the gearing profiles (53, 54) provided on the axially moveable sliding sleeve (31) and on the hollow shaft (21) which is in a fixed connection with the machine spindle (5).

10. The clamping device in accordance with claim 9,
wherein
the gearing profiles (46; 53) provided on the axially moveable sliding sleeve (31) are each formed with a toothed segment (48; 46).

11. The clamping device in accordance with claim 2,
wherein
the bell (14) and the axially moveable intermediate element (24) are in a rotational mounting on the hollow shaft (21) connected to the machine spindle by means of spindle bearings (37, 38).

12. The clamping device in accordance with claim 9,
wherein
the bell (14), the axially moveable intermediate element (24), the sliding sleeve (31), the bearing race (39) of the bell (14), the sleeve (55) and additional components of the clamping device (1, 1′, 1″) are each provided with one or more coolant ducts (63, 64, 65, 66).

13. The clamping device in accordance with claim 12,
wherein
the coolant ducts (63, 64, 65, 66) are provided with throttles (67), in end areas of the coolant ducts (63, 64, 65, 66).
